(19) United States
(12) Patent Application Publication
(10) Pub. No.: US 2006/0255907 A1
(43) Pub. Date: Nov. 16, 2006

(54) Fingerprint Lock

(76) Inventor: Hao Min, Najing Jiangsu Province (CN)

Correspondence Address: GLOBAL IP SERVICES, 2462 ROCK ST., APT. 6, MOUNTAIN VIEW, CA, 94043, US

(21) Appl. No.: 11/277,508

(22) Filed: Mar. 26, 2006

(30) Foreign Application Priority Data
May 16, 2005 (CN) 200520071665.8
Nov. 1, 2005 (CN) 200520133844.X

(51) Int. Cl. G06K 9/00

(52) U.S. Cl. 340/5.53; 382/124

(57) ABSTRACT

Present invention discloses a kind of fingerprint locks in which the power of the fingerprint sensor is controlled by an infrared transceiver module. The sensor is normal in power off status if it is not in use and can be powered on automatically to identify the fingerprint if a finger touches the fingerprint sensor. It includes the lock case (1), the fingerprint sensor (2) which is installed on the lock case (1) and an infrared transceiver module (3) which is installed nearby the fingerprint sensor (2) in order to switch on or switch off the power of the fingerprint sensor (2). The benefit of the present invention is that it has simple construction and long lifetime.

### CROSS REFERENCE TO RELATED APPLICATION

This application claims the priority benefits of a Chinese patent application No. 200520071665.8 filed on May 16, 2005 and a Chinese patent application No. 200520133844.X filed on Nov. 1, 2005.

### FIELD OF THE INVENTION

The present invention relates to electronic locks, especially fingerprint locks.

BACKGROUND OF THE INVENTION

It is well known that each one's fingerprints are unique from others. So far, the scientists have not yet detected two people with the same fingerprint. Therefore, the exclusive identification character of fingerprints has been widely used in many fields for a long time, such as public security and the criminal investigation. In recent years, with the development and advancement of the computer technology, the fingerprint locks using the exclusive identification character of the fingerprint have become more perfect day by day. It has made great contributions to the fields of safety and burglary defense. It has already been a top grade lock device and widely used as a safeguard in the field of finance, insurance, cultural relic, office and house etc. Conventional fingerprint locks comprise four parts: fingerprint sensor, central processing circuit, signal input-output device and locking mechanism. The central processing circuit, signal input-output device and locking mechanism are all installed in a lock case. The fingerprint sensor is then installed on the surface of the lock case, which is connected to the central processing circuit with wire. In addition, there are auxiliary devices on the lock case nearby the fingerprint sensor generally, such as an input keypad and a small display screen. Conventional fingerprint locks found in the prior art, however, have some shortcomings. The fingerprint sensor always needs to be activated by power in order to detect the fingerprint of someone at any time. This will seriously decrease its lifetime of the fingerprint sensor. Some fingerprint locks comprise a power switch to eliminate this shortcoming; It is switched on before detection and switched off after detection. But this kind of fingerprint locks is inconvenient to use and install, difficult to configure, and has poor appearance. In addition, the lifetime of the power switch is limited. These shortcomings need to be improved urgently.

### SUMMARY OF THE INVENTION

The aim of present invention is to provide a kind of fingerprint locks with an infrared transceiver module that automatically makes the fingerprint sensor to be power off status if it is not in use and to be powered on status if a user's finger touches the fingerprint sensor.

The technique scheme of present invention is:

A fingerprint lock comprises a lock case 1, a fingerprint sensor 2 installed on the lock case 1, wherein further having an infrared transceiver module 3 for controlling the fingerprint sensor 2 to be on or off status, which is installed near the fingerprint sensor 2.

The infrared transceiver module 3 includes at least one infrared transmitter 301 and one infrared receiver 302. The distance from the infrared transmitter 301 and the infrared receiver 302 to the center of the fingerprint sensor 2 is less than 80 mm; the location deviation is less than 15 mm from left to right and less than 15 mm from top to bottom. The infrared transmitter 301 and the infrared receiver 302 are connected with a normal transmitting and receiving circuit, which triggers a power circuit to supply power to the fingerprint sensor when receiving a signal. The infrared transmitter 301 is activated by a pulse voltage, the width of the pulse voltage is less than 1/10 of the period thereof.

The benefits of present invention are as follows:

1, the infrared transceiver module has long lifetime, therefore, it can work for long time without failure. Thus, the fingerprint sensor can be avoided in power on status long time, which will extend the MTBF and lifetime of the fingerprint sensor.

2, the configuration is simple, the circuit is very simple and feasible.

3, the installation is easy, the infrared transceiver module can be installed on the same or different plane with the fingerprint sensor. If using reflection style of infrared transceiver module, the infrared can be reflected from the transmitter to the receiver by finger or palm when they reach the lock, then the concerned circuit works to power the fingerprint sensor. In addition, the infrared transmitter and the infrared receiver can be separately installed on two sides of the fingerprint sensor if using obstruction style of infrared transceiver module, the infrared can be obstructed by finger when it moves toward the fingerprint sensor, this also means a signal trigger, then the concerned circuit works to power the fingerprint sensor.

### BRIEF DESCRIPTION OF THE DRAWINGS

FIG. 1 depicts a schematic diagram of present invention in which a single infrared transceiver module is installed.

FIG. 2 depicts a schematic diagram of present invention in which an infrared transmitter and an infrared receiver are installed separately on the two sides of the fingerprint sensor.

FIG. 3 depicts a schematic diagram of the infrared transceiver module of present invention.

FIG. 3A is a magnified drawing of the right part of the FIG. 3.

FIG. 3B is a magnified drawing of the left part of the FIG. 3.

### DETAIL DESCRIPTION OF THE INVENTION

The present invention will be further described in details with reference to the accompanying drawings.

Although the following detailed description contains many specifics for the purposed of illustration, any one of ordinary skill in the art will appreciate that many variations and alterations to the following details are within the scope of the invention. Accordingly, the following preferred embodiment of the invention is set forth without any loss of generality to, and without imposing limitations upon, the claimed invention.

### EMBODIMENT 1

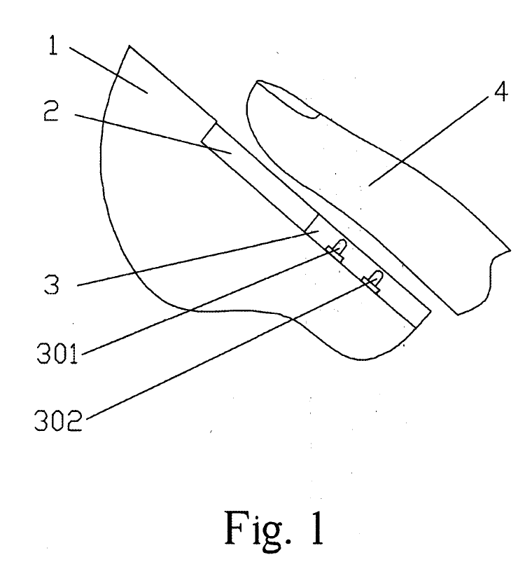

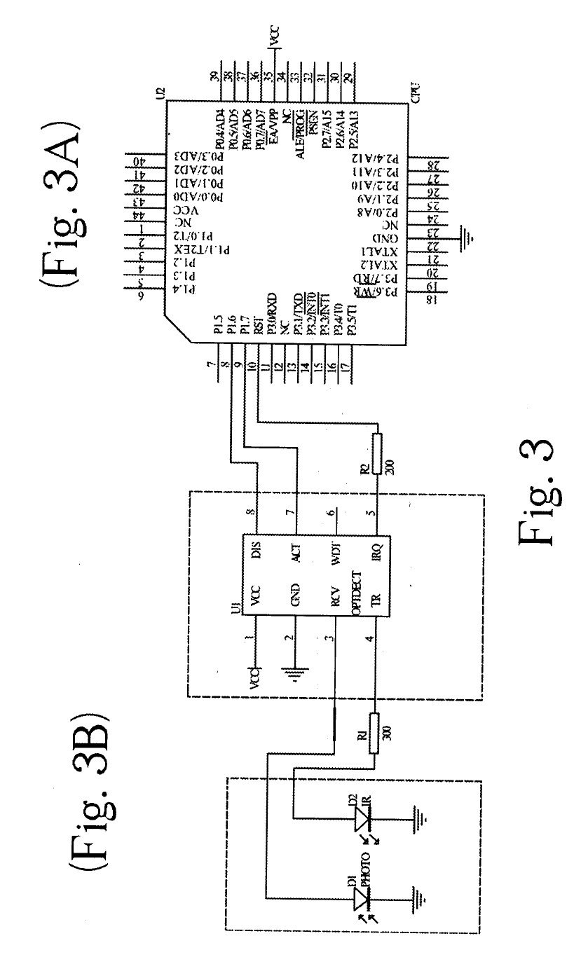

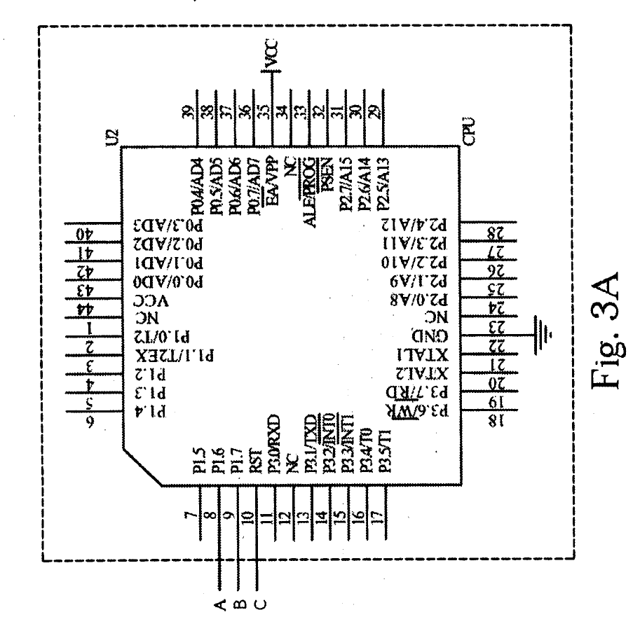

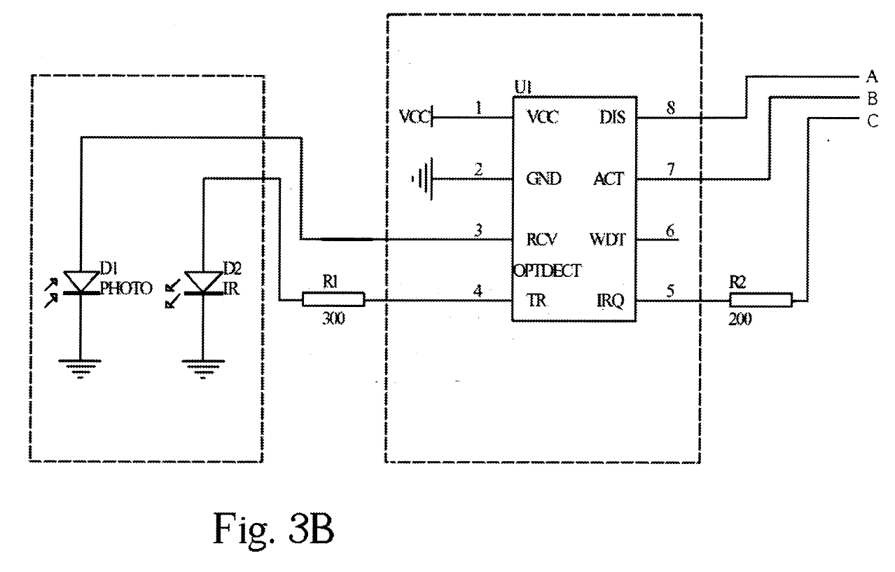

As shown in FIG. 1 and FIG. 3, a fingerprint lock comprises a lock case 1, a fingerprint sensor 2 which is installed on the lock case 1, an infrared transceiver module 3 which is installed nearby the sensor 2 in order to control the power supply on or off for the sensor 2. The infrared transceiver module 3 can be made up of an infrared transmitter 301, an infrared receiver 302 and concerned transmitting and receiving circuit, which is normal circuit, belong to common knowledge. When installing, the better thing is that the distance from the infrared transmitter 301 and the infrared receiver 302 to the center of the sensor 2 is less than 80 mm; the location deviation is less than 15 mm from left to right and less than 15 mm from top to bottom. The infrared transmitter 301 and the infrared receiver 302 are connected to the normal transmitting and receiving circuit. If the infrared signal transmitted from the transmitter is reflected by finger 4 to the receiver, it triggers a power control circuit at once, which is connected with the infrared transmitting and receiving circuit, to switch the power on for the sensor 2. In practicing, the infrared transmitter 301 can be activated by a pulse voltage, the width of the pulse voltage is less than 1/10 of the period thereof. The other parts for this embodiment, such as the signal processing circuit of sensor, memory device, central processing circuit, input and output control circuit, locking mechanism and power circuit are prior arts and common knowledge.

The working procedure of this embodiment is as follows:

The sensor 2 is always in power off status without power if no finger points to it. The infrared transmitter 301 and the infrared receiver 302 are always in active status. The infrared signal transmitted by the infrared transmitter 301, which is installed nearby the sensor 2, will be reflected by finger 4 to the infrared receiver 302 if the finger 4 moves to the sensor 2. The signal received by infrared receiver 302 then is fed back to the receiving circuit. It triggers concerned circuit at once, makes the sensor 2 activating by power and working. The sensor 2 scans the fingerprint located on it, compares with the fingerprint data already stored, controls the locking mechanism to open the lock if the user is legal or sends out some hint or activates alarm if the user is illegal.

### EMBODIMENT 2

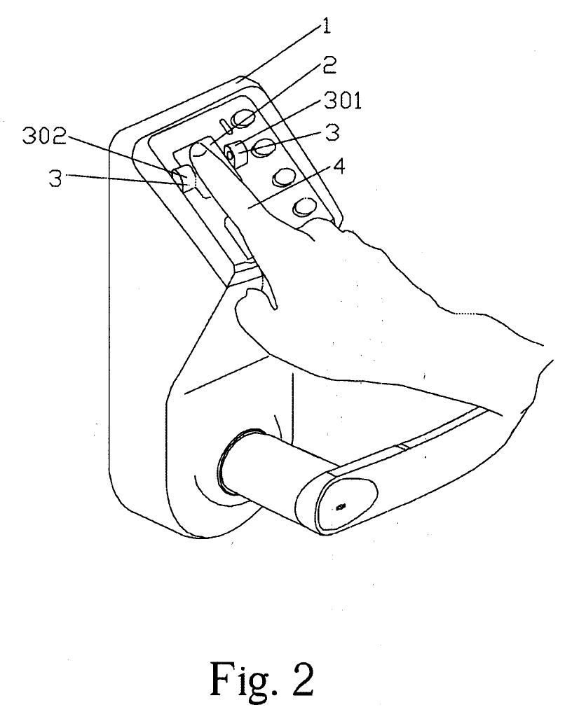

As shown in FIG. 2 and FIG. 3, a fingerprint lock comprises a lock case 1, a fingerprint sensor 2 which is installed on the lock case 1, a infrared transceiver module 3 which is installed on the two sides of the sensor 2 (as shown in FIG. 3) in order to control the power supply on or off for the sensor 2. The infrared transceiver module 3 can be made up of an infrared transmitter 301, an infrared receiver 302 and a concerned transmitting and receiving circuit which are normal circuits, belong to prior arts and common knowledge. When installing, the better thing is that the space between the infrared transmitter 301 and the infrared receiver 302 is less than 15 mm. The infrared transmitters 301 and 302 are connected to the normal transmitting and receiving circuit. If the infrared transmitted from the transmitter to the receiver is obstructed by a finger, it triggers the power control circuit at once, which is connected the infrared transmitting and receiving circuit, to switch the power on for the sensor 2. In practicing, the infrared transmitter 301 can be activated by a pulse voltage, the width of the pulse voltage is less than 1/10 of the period thereof. The other parts not referred to in the specification are prior arts and common knowledge, such as the signal processing circuit of sensor, memory device, central processing circuit, input and output control circuit, locking mechanism and power circuit.

The working procedure of this embodiment is as follows:

The sensor 2 is always in power off status if no finger 4 points it. The infrared transmitter 301 and the infrared receiver 302 are always in the active status. The infrared signal transmitted by the infrared transmitter 301 will be obstructed by finger 4 and can not reaches to the infrared receiver 302 if the finger 4 moves toward the sensor 2. It triggers concerned circuit at once, makes the sensor 2 activating by power and working. The sensor 2 scans the fingerprint located on it, compares the same with the fingerprint data already stored, controls the locking mechanism to open the lock if the user is legal or sends out some hints or activates alarm if the user is illegal.

What is claimed is:

1. A fingerprint lock comprising:
(1) a lock case;
(2) a fingerprint sensor installed on said lock case;
(3) a infrared transceiver module installed nearby said fingerprint sensor for controlling the power of said fingerprint sensor on or off.

2. The fingerprint lock of claim 1 wherein said infrared transceiver module comprises at least one infrared transmitter and one infrared receiver, and the distance from said transmitter and said receiver to the center of said fingerprint sensor is less than 80 mm; a location deviation is less than 15 mm from top to bottom.

3. The fingerprint lock of claim 2 wherein said infrared transmitter is activated by a pulse voltage, the wide the pulse voltage is less than 1/10 of the period thereof.

4. The fingerprint lock of claim 1 wherein when a finger moves to said fingerprint sensor, said infrared transceiver module makes the fingerprint sensor to be power on status, when a finger leaves said fingerprint sensor, said infrared transceiver module makes the fingerprint sensor to be power off status.

5. The fingerprint lock of claim 2 wherein the space between said infrared transmitter and said infrared receiver is less than 15 mm.
